(19) United States
(12) Patent Application Publication
(10) Pub. No.: US 2025/0363823 A1
(43) Pub. Date: Nov. 27, 2025

(54) APPARATUS AND METHOD FOR COUNTING PEOPLE BASED ON FACE DETECTION

(71) Applicant: ELECTRONICS AND TELECOMMUNICATIONS RESEARCH INSTITUTE, Daejeon (KR)

(72) Inventors: Jang-Hee YOO, Daejeon (KR); Dong-Hwan LEE, Daejeon (KR); Moon-Ki BACK, Daejeon (KR); Cheol-Hwan YOO, Daejeon (KR)

(21) Appl. No.: 18/971,187

(22) Filed: Dec. 6, 2024

(30) Foreign Application Priority Data
May 24, 2024 (KR) 10-2024-0067677

(51) Int. Cl. G06V 40/16

(52) U.S. Cl. CPC G06V 40/161

(57) ABSTRACT

Disclosed herein is an apparatus and method for counting people based on face detection. The apparatus detects the face of a person in a video input through a camera, retrieves the detected face to check whether the detected face is a face registered in any one of short-term memory and long-term memory, counts the person of the detected face when the detected face is not retrieved from the short-term memory or the longer-term memory, registers the face of the counted person in the short-term memory, transfers the face registered in the short-term memory to the long-term memory to be registered therein when the face registered in the short-term memory remains for a preset time or longer, and deletes faces previously registered in the long-term memory in a First-In-First-Out (FIFO) manner when the number of faces registered in the long-term memory exceeds a predefined number.

### CROSS REFERENCE TO RELATED APPLICATION

This application claims the benefit of Korean Patent Application No. 10-2024-0067677, filed May 24, 2024, which is hereby incorporated by reference in its entirety into this application.

### BACKGROUND OF THE INVENTION

### 1. Technical Field

The present disclosure relates generally to technology for counting people, and more particularly to technology for counting people based on face detection.

### 2. Description of Related Art

With the development of Artificial Intelligence (AI) technology, the widespread adoption of CCTV, and the expansion of distribution industry, people-counting systems have become essential. As customers are more inclined to purchase products online rather than in retail, many distributors intend to introduce customer management solutions. Also, through such customer management solutions, the distributors are trying to enhance store operations and increase customer satisfaction and profitability. A people-counting system, which is one of the core technologies of customer management solutions, has evolved from a simple IR sensor method to a method of combining sensors with CCTV cameras, RGB-depth cameras, and CCTV-based systems. In particular, the latest 4D technology is developed and used as technology that can further improve the accuracy of counting people by combining 3D cameras and passive sensors, such as RFID sensors, to detect residents. This method may provide various advantages but has many limitations in solving the problem of duplicate counting of the same person, along with the problems of installing additional devices and increasing the cost. Particularly, it is difficult to effectively implement a people-counting system in existing CCTV cameras. Therefore, what is required is a method and apparatus capable of solving the problem of duplicate counting of residents and an accuracy problem without installation of additional devices in existing environments including CCTVs, which are widely distributed because of easy installation.

Meanwhile, Korean Patent No. 10-1558258, titled “People counter using TOF camera and counting method thereof”, relates to a people counter using a TOF camera and a counting method thereof, and specifically, it discloses a people counter using a TOF camera and a counting method thereof that enable objects corresponding to people to be easily identified and counted by filtering objects moving in video based on depth information obtained through the TOF camera.

### SUMMARY OF THE INVENTION

An object of the present disclosure is to improve the accuracy and efficiency of a system for counting people based on face detection in an environment using existing CCTV cameras, or the like.

Another object of the present disclosure is to improve accuracy by minimizing duplicate counting of detected faces.

In order to accomplish the above objects, an apparatus for counting people based on face detection according to an embodiment of the present disclosure includes one or more processors and memory for storing at least one program executed by the one or more processors, and the at least one program detects a face of a person in a video input through a camera, retrieves the detected face to check whether it is a face registered in any one of short-term memory and long-term memory, counts the person of the detected face when the detected face is not retrieved from the short-term memory or the longer-term memory, registers the face of the counted person in the short-term memory, transfers the face registered in the short-term memory to the long-term memory and registers the same in the long-term memory when the face registered in the short-term memory remains for a preset time or longer, and deletes a face previously registered in the long-term memory in a First-In-First-Out (FIFO) manner when the number of faces registered in the long-term memory exceeds a predefined number.

Here, when the detected face is not retrieved from the short-term memory or the long-term memory, the at least one program may check whether the face detected in a currently input video frame is identical to a face detected in a previously input video frame and may count the person when the two faces are identical to each other.

Here, when the number of video frames of the face detected as the identical face in the input video is equal to or greater than a preset number, the at least one program may count the person of the detected face.

Here, when the detected face is retrieved from the short-term memory, the at least one program may record a matching rate for the ID of the registered face based on the number of times the registered face identical to the detected face is retrieved from the short-term memory.

Here, the at least one program may transfer the face registered in the short-term memory to the long-term memory when the matching rate is equal to or less than a preset value.

Here, the at least one program may manage the number of faces registered in the long-term memory based on a predefined length of a First-In-First-Out (FIFO) queue.

Here, when the number of faces registered in the long-term memory exceeds the predefined length of the queue, the at least one program may delete the registered faces in the order in which the faces are registered.

Here, the long-term memory may include a first part in which faces transferred from the short-term memory are stored based on the length of the queue and a second part in which faces of preregistered residents are stored.

Here, the second part of the long-term memory may include the stay duration of the residents, and the faces of residents whose stay duration has passed may be excluded from retrieval.

Also, in order to accomplish the above objects, a method for counting people based on face detection, performed by an apparatus for counting people based on face detection, according to an embodiment of the present disclosure includes detecting a face of a person in a video input through a camera, retrieving the detected face to check whether it is a face registered in any one of short-term memory and long-term memory, counting the person of the detected face when the detected face is not retrieved from the short-term memory or the longer-term memory, transferring the face registered in the short-term memory to the long-term memory and registering the same in the long-term memory when the face registered in the short-term memory remains for a preset time or longer, and deleting a face previously registered in the long-term memory in a First-In-First-Out (FIFO) manner when the number of faces registered in the long-term memory exceeds a predefined number.

Here, counting the person of the detected face may comprise, when the detected face is not retrieved from the short-term memory or the long-term memory, checking whether the face detected in a currently input video frame is identical to a face detected in a previously input video frame and counting the person when the two faces are identical to each other.

Here, counting the person of the detected face may comprise, when the number of video frames of the face detected as the identical face in the input video is equal to or greater than a preset number, counting the person of the detected face.

Here, retrieving the detected face may comprise, when the detected face is retrieved from the short-term memory, recording a matching rate for the ID of the registered face based on the number of times the registered face identical to the detected face is retrieved from the short-term memory.

Here, registering the face may comprise transferring the face registered in the short-term memory to the long-term memory when the matching rate is equal to or greater than a preset value.

Here, deleting the face may comprise managing the number of faces registered in the long-term memory based on a predefined length of a First-In-First-Out (FIFO) queue.

Here, deleting the face may comprise, when the number of faces registered in the long-term memory exceeds the predefined length of the queue, deleting the registered faces in the order in which the faces are registered.

Here, the long-term memory may include a first part in which faces transferred from the short-term memory are stored based on the length of the queue and a second part in which faces of preregistered residents are stored.

Here, the second part of the long-term memory may include the stay duration of the residents, and faces of residents whose stay duration has passed may be excluded from retrieval.

### BRIEF DESCRIPTION OF THE DRAWINGS

The above and other objects, features, and advantages of the present disclosure will be more clearly understood from the following detailed description taken in conjunction with the accompanying drawings, in which:

FIGS. 1 to 5 are views illustrating a process of counting people based on face detection according to an embodiment of the present disclosure;

FIG. 6 is a block diagram illustrating an apparatus for counting people based on face detection according to an embodiment of the present disclosure;

FIG. 7 is a flowchart illustrating a method for counting people based on face detection according to an embodiment of the present disclosure;

FIG. 8 is a view illustrating the operation process of a system for counting people based on face detection according to an embodiment of the present disclosure; and

FIG. 9 is a view illustrating a computer system according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to unnecessarily obscure the gist of the present disclosure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated in order to make the description clearer.

Throughout this specification, the terms “comprises” and/or “comprising” and “includes” and/or “including” specify the presence of stated elements but do not preclude the presence or addition of one or more other elements unless otherwise specified.

Hereinafter, a preferred embodiment of the present disclosure will be described in detail with reference to the accompanying drawings.

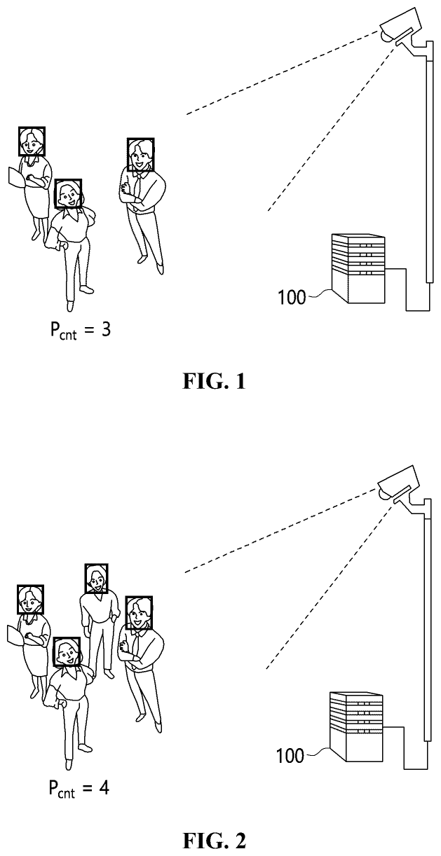

FIGS. 1 to 5 are views illustrating the process of counting people based on face detection according to an embodiment of the present disclosure.

The apparatus 100 for counting people based on face detection according to an embodiment of the present disclosure detects and tracks a face in the video of a remote CCTV camera connected through a network. Here, the apparatus 100 may transmit only the detected face image to a server after processing face detection in the camera (edge) or transmit the CCTV video to the server to process face detection therein.

FIGS. 1 to 5 illustrate a method in which the apparatus 100 for counting people based on face detection counts a person only when a detected face is not registered in short-term or long-term memory that is continuously and automatically managed over time according to a change of circumstances.

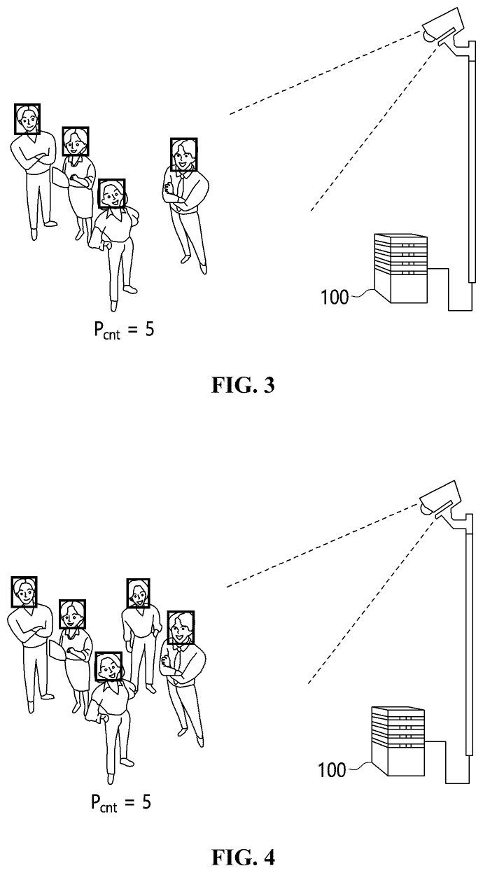

It can be seen that the count is 3 (P_{cnt}=3) in FIG. 1, the count is 4 (P_{cnt}=4) in FIG. 2, the count is 5 (P_{cnt}=5) in FIG. 3 because a person counted in the previous screen disappeared from the screen but a new person appears, and the count is maintained at 5 (P_{cnt}=5) in FIG. 4 because the person who disappeared after being counted in FIG. 2 and then reappears is treated as a duplicate.

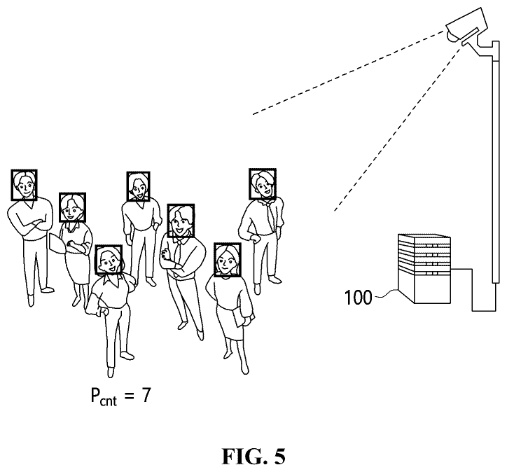

Also, it can be seen that the result of counting becomes 7 (P_{cnt}=7) in FIG. 5 because two new people appear.

Therefore, the apparatus 100 for counting people based on face detection has the advantage of improving accuracy by removing duplicate or resident individuals through face recognition technology.

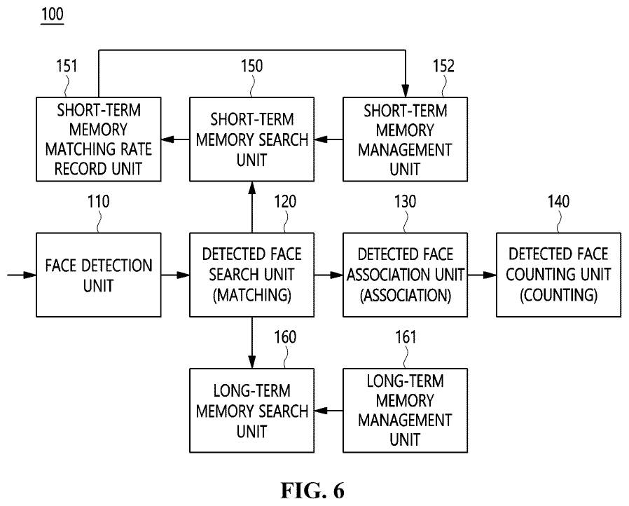

FIG. 6 is a block diagram illustrating an apparatus for counting people based on face detection according to an embodiment of the present disclosure.

Referring to FIG. 6, the apparatus 100 for counting people based on face detection according to an embodiment of the present disclosure may include a face detection unit 110, a detected face search unit 120, a detected face association unit 130, a detected face counting unit 140, a short-term memory search unit 150, a short-term memory matching rate record unit 151, a short-term memory management unit 152, a long-term memory search unit 160, and a long-term memory management unit 161.

The face detection unit 110 may detect or track the face of a person in real time in a video input through a camera.

Here, through the process of detecting or tracking a face in the video input through the camera, the face detection unit 110 may continuously obtain a face region while the face is seen in the Field of View (FoV) of the camera.

Here, the face detection unit 110 may ensure a certain level of quality or higher, such as a face image close to a frontal view through pose estimation on the obtained face region.

Here, the face detection unit 110 mainly uses a deep-learning-based face detector or the like, but may also use a Viola face detector, which uses an Adaboost classifier.

Here, the face detection unit 110 may perform the function of continuously tracking the detected face region in order to reduce the amount of calculation and respond to occlusion, and may use the Kalman filter, the Particle filter, a deep-learning-based learning model, or the like.

The detected face search unit 120 may retrieve a newly detected face to check whether it is a face stored in the short-term or long-term memory in order to minimize duplicate counting of the person of the face already included in the count.

Here, in order to minimize duplication errors, the detected face search unit 120 may check whether the detected face is already counted or not by retrieving it from the short-term memory and the long-term memory only when the number of occurrences of the face is equal to or greater than a predefined number according to an operation environment.

Here, the detected face search unit 120 may use a matching method that compares the similarity between facial features extracted through various techniques including a deep-learning-based feature extraction technique.

When the detected face is a new face that is not retrieved from the short-term memory or the long-term memory, the detected face association unit 130 may perform initial association for checking whether it is the same face as the face detected in the previously input video.

Here, the detected face association unit 130 may determine the detected face to be a new face when the number of video frames of the face detected as the same face in the input video is equal to or greater than a preset number.

When the detected face is a new face that is not retrieved from the short-term memory or the long-term memory, the detected face counting unit 140 may perform counting and perform the process of registering the face in the short-term memory in order to prevent duplicate counting.

The short-term memory search unit 150 may retrieve the input face to check whether it is a face registered in the short-term memory in response to a request from the detected face search unit 120.

Here, when the number of occurrences of the detected face in the previous video is equal to or greater than a preset number, the short-term memory search unit 150 may count the person of the detected face and register the detected face in the short-term memory.

Here, when the detected face is retrieved from the short-term memory, the short-term memory search unit 150 may record a matching rate for the ID of the registered face in the short-term memory matching rate record unit 151 based on the number of times the registered face that is the same as the detected face is retrieved from the short-term memory.

The short-term memory management unit 152 may perform the function of retaining the registered face in the short-term memory only for a predefined time.

Here, the short-term memory management department 152 may manage the registered faces based on time.

Here, when the registered face remains in the short-term memory for a preset time or longer, the short-term memory management unit 152 may transfer the face registered in the short-term memory to the long-term memory and register the same as a face that is not counted.

Here, the short-term memory management unit 152 may transfer the face stored in the short-term memory to the long-term memory by further considering the number of times the detected face matches the registered face (matching rate), which is recorded in the short-term memory matching rate record unit 151.

Here, when the matching rate is equal to or greater than a preset value, the short-term memory management unit 152 may discard the face registered in the short-term memory or transfer the same to the long-term memory.

This is for excluding people who simply pass by without interest in products or exhibits from the total count in terms of a customer management solution.

The long-term memory search unit 160 may retrieve the input face to check whether it is a face registered in the long-term memory in response to a request from the detected face search unit 120.

The long-term memory management unit 161 may manage faces that are registered after being transferred from the short-term memory.

Here, when the number of faces registered in the long-term memory exceeds a predefined number, the long-term memory management unit 161 may delete the faces registered in the long-term memory in a First-In-First-Out (FIFO) manner.

Here, the long-term memory management unit 161 may manage the number of faces registered in the long-term memory based on the predefined length of a FIFO queue.

Here, when the number of faces registered in the long-term memory exceeds the predefined length of the queue, the long-term memory management unit 161 may delete the registered faces in the order in which they were registered.

Also, the long-term memory management unit 161 may register the faces of residents that need to be excluded from counting as uncountable faces (uncountable IDs).

Here, the long-term memory management unit 161 may register, exclude, or delete the residents, and register and manage the stay duration and the like according to need.

Here, the long-term memory may include a first part in which the faces transferred from the short-term memory are stored based on the length of the queue and a second part in which the faces of the preregistered residents are stored.

Here, the second part of the long-term memory includes the stay duration of the residents, and the face of the residents whose stay duration has passed may be excluded from retrieval.

As described above, the short-term memory and the long-term memory are complementary mechanisms and may provide a method capable of improving efficiency and performance in people counting.

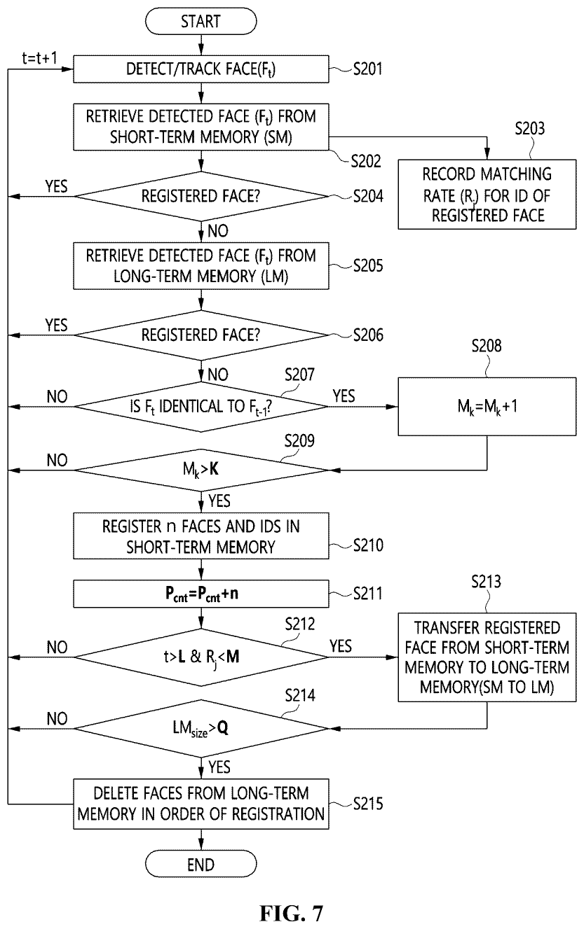

FIG. 7 is a flowchart illustrating a method for counting people based on face detection according to an embodiment of the present disclosure.

Referring to FIG. 7, in the method for counting people based on face detection according to an embodiment of the present disclosure, first, face detection and tracking may be performed at step S201.

That is, at step S201, a video image including faces may be received as input through a camera in order to count people.

Here, at step S201, a face may be detected and tracked in the image input from the camera.

At step S202, the detected face image may be retrieved from short-term memory.

At step S203, when a registered face that is the same as the detected face is retrieved from the short-term memory, a matching rate Rⱼ corresponding to the number of times the face is retrieved may be recorded for the ID of the registered face.

At step S204, when the detected face is retrieved from the short-term memory, the face retrieved from (registered in) the short-term memory is a face that has already been counted, so the next frame image may be received as input at step S201.

Also, when the detected face is not a face registered in the short-term memory at step S204, the face image may be retrieved from long-term memory at step S205.

At step S205, when the face is retrieved from the long-term memory, the face is a face that has already been counted or a face that does not need to be counted, so the next frame image may be received as input at step S201.

Also, when the detected face is not retrieved from the short-term memory or the long-term memory at step S206, initial association for checking whether the face Fₜ detected in the current image frame is the same as the face Fₜ₋₁ detected in the image frame that is input immediately before the current image frame may be performed at step S207.

Here, at step S207, because multiple faces can be detected at the same time, whether each of the faces is consecutively detected may be recorded (Mₖ) at step S208.

When the face is the same as the previous face, the number of occurrences of the face may increase (Mₖ=Mₖ+1) at step S208.

At step S209, when the number of consecutive or cumulative occurrences Mₖ exceeds a predefined threshold K, the face may be determined to be a new face, so it may be registered in the short-term memory at step S210.

Here, at step S209, when the number of image frames of the face detected as the same face in the input video is equal to or greater than a preset number, the face may be determined to be a new face.

At step S210, counting people may be performed based on the faces registered in the short-term memory.

Here, at step S210, multiple faces may satisfy the defined criterion, so all faces satisfying the criterion may be registered in the short-term memory.

At step S211, people of the faces newly registered in the short-term memory may be counted.

Here, at step S211, the number of faces registered in the short-term memory may be added to the count (P_{cnt}=P_{cnt}+n).

Also, the threshold K for the number of occurrences of a face for determining a new face may be predefined in consideration of an operation environment, or the like.

At step S212, when the face registered in the short-term memory remains longer than a preset time L and when the matching rate Rⱼ is less than a reference value M, the face may be deleted from the short-term memory.

Here, at step S212, when the matching rate Rⱼ is greater than the reference value M, the face registered in the short-term memory may be transferred to and registered in the long-term memory at step S213.

Here, at step S213, the face registered in the short-term memory (SM) may be transferred to the long-term memory (LM) and may be registered and maintained as the face that is not counted.

At step S214, when the number of faces registered in the long-term memory exceeds a predefined number, the face registered in the long-term memory may be deleted in a First-In-First-Out (FIFO) manner.

Here, at step S214, the number of faces registered in the long-term memory may be managed based on the predefined length of a FIFO queue.

Here, at step S214, the long-term memory managed based on the predefined length of the queue is used, and when the length Q of the queue of the face images is greater than the size of the long-term memory, the previously registered faces may be deleted in the order in which they were registered at step S215.

As described above, the process from step S201 to step S215 is repeated for each video frame, and finally the number of people is counted.

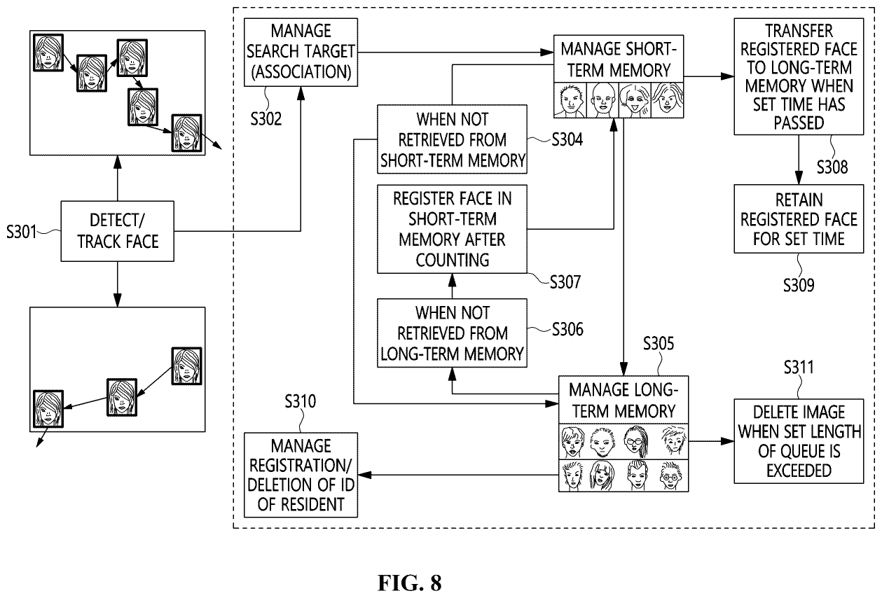

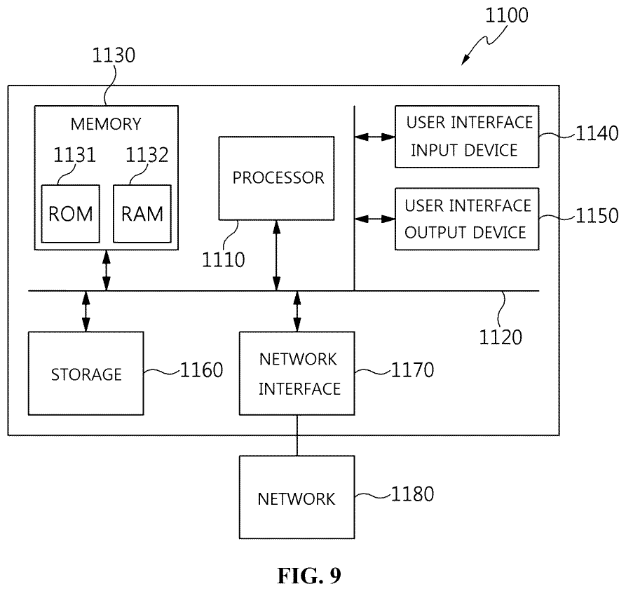

FIG. 8 is a view illustrating the operation process of a system for counting people based on face detection according to an embodiment of the present disclosure.

Referring to FIG. 8, it can be seen that the operation process of the system for counting people based on face detection according to an embodiment of the present disclosure is illustrated.

At step S301, the face of a person may be detected or tracked in real time in a video input through a camera.

Here, through the process of detecting or tracking a face in the video input through the camera, a face region may be continuously obtained while the face is seen in the Field of View (FoV) of the camera at step S301.

Here, at step S301, a certain level of quality or higher, such as a face image close to a frontal view, may be guaranteed through pose estimation on the obtained face region.

Here, at step S301, a deep-learning-based face detector is mainly used, but a Viola face detector, which uses an Adaboost classifier, may also be used.

Here, at step S301, the function of continuously tracking the detected face region is performed in order to reduce the amount of calculation and respond to occlusion, and the Kalman filter, the Particle filter, a deep-learning-based learning model, or the like may be used.

At step S302, a face that can be registered in short-term memory is selected from among the newly detected faces in order to minimize duplicate counting of the person for the same face.

Here, at step S302, when the detected face is not retrieved from the short-term memory or long-term memory, whether the face detected in the currently input video frame is the same as the face detected in the previously input video frame may be checked.

At step S302, when the detected face is a new face that is not retrieved from the short-term memory or the long-term memory, initial association for checking whether the face Fₜ detected in the current video frame is the same as the face Fₜ₋₁ detected in the video frame input immediately before the current video frame may be performed.

Here, at step S302, multiple faces may be detected at the same time, so whether each of the faces is consecutively detected may be recorded (Mₖ).

Here, at step S302, when the detected face is the same as the previous face, the number of occurrences of the face may increase (Mₖ=Mₖ+1).

Here, at step S302, the number of video frames of the face detected as the same face in the input video is equal to or greater than a preset number, the person of the detected face may be counted.

Here, at step S302, when the number of consecutive or cumulative occurrences of the face (Mₖ) exceeds a predefined threshold K according to an operation environment, the face may be determined to be a new face and selected as a target that can be registered in the short-term memory in order to minimize duplication errors.

At step S303, the input face may be retrieved to check whether it is registered in the short-term memory.

At step S303, the detected face may be registered in the short-term memory.

Here, at step S303, when the detected face is retrieved from the short-term memory, a matching rate based on the number of times the registered face that is the same as the detected face is retrieved from the short-term memory may be recorded for the ID of the registered face.

At step S304, when the detected face is not retrieved from the short-term memory, the detected face may be forwarded to step S305 in order to retrieve the detected face from the long-term memory.

Here, at step S305, when the detected face is not a face registered in the short-term memory, the face image may be retrieved from the long-term memory.

Here, at step S305, when the face is successfully retrieved from the long-term memory, it is a face that has already been counted or a face that does not need to be counted, so the next frame image may be received as input.

At step S306, whether the input face is a face registered in the long-term memory may be checked.

At step S307, when it is determined that the face is selected as the target that can be registered in the memory at step S302 because the number of consecutive or cumulative occurrences Mₖ exceeds the predefined threshold K, the face may be registered in the short-term memory.

Here, at step S307, counting people may be performed for the faces registered in the short-term memory.

Here, at step S307, the number of faces registered in the short-term memory may be added to the count (P_{cnt}=P_{cnt}+n).

Here, at step S307, because multiple faces may satisfy a defined criterion at the same time, all faces satisfying the criterion may be registered in the short-term memory.

Also, the threshold K for the number of occurrences of a face for determining a new face may be predefined in consideration of an operation environment, or the like.

At step S308, when the face registered in the short-term memory remains longer than a preset time L and when the matching rate Rⱼ is less than a reference value M, the face may be deleted from the short-term memory.

Here, at step S308, when the matching rate Rⱼ is greater than the reference value M, the face registered in the short-term memory may be transferred to and registered in the long-term memory.

Here, at step S308, the face registered in the short-term memory is transferred to the long-term memory, whereby the face may be registered and maintained as the face that is not counted.

At step S308, when the face registered in the short-term memory remains longer than a preset time in consideration of the operation environment, the registered face may be transferred to the long-term memory.

Here, at step S308, when the rate of matching between the detected face and the registered face is equal to or greater than a preset value, the face may be discarded from the short-term memory or transferred to the long-term memory.

At step S309, when the time during which the registered face remains does not exceed the preset time, the registered face may be retained in the short-term memory for the preset time.

This is for excluding people who simply pass by without interest in products or exhibits from the total count in terms of a customer management solution.

At step S310, the faces of residents that need to be excluded from counting may be registered as uncountable faces (uncountable IDs).

Here, at step S310, the residents may be registered, excluded, or deleted, and the stay duration may be registered and managed according to need.

Here, the long-term memory may include a first part in which the faces transferred from the short-term memory are stored based on a preset queue length and a second part in which the faces of preregistered residents are stored.

Here, the second part of the long-term memory includes the stay duration of the residents, and the face of the residents whose stay duration has passed may be excluded from retrieval.

At step S311, when the number of faces registered in the long-term memory exceeds a predefined number, the faces registered in the long-term memory may be deleted in a First-In-First-Out (FIFO) manner.

Here, at step S311, for the faces received from the short-term memory, the number of faces registered in the long-term memory may be managed based on the predefined length of a FIFO queue.

Here, at step S311, when the number of faces registered in the long-term memory exceeds the preset queue length, the registered faces may be deleted in the order in which they were registered.

FIG. 9 is a view illustrating a computer system according to an embodiment of the present disclosure.

Referring to FIG. 9, the apparatus 100 for counting people based on face detection according to an embodiment of the present disclosure may be implemented in a computer system 1100 including a computer-readable recording medium. As illustrated in FIG. 9, the computer system 1100 may include one or more processors 1110, memory 1130, a user-interface input device 1140, a user-interface output device 1150, and storage 1160, which communicate with each other via a bus 1120. Also, the computer system 1100 may further include a network interface 1170 connected to a network 1180. The processor 1110 may be a central processing unit or a semiconductor device for executing processing instructions stored in the memory 1130 or the storage 1160. The memory 1130 and the storage 1160 may be any of various types of volatile or nonvolatile storage media. For example, the memory may include ROM 1131 or RAM 1132.

The apparatus for counting people based on face detection according to an embodiment of the present disclosure includes one or more processors 1110 and memory 1130 for storing at least one program executed by the one or more processors 1110, and the at least one program detects the face of a person in a video input through a camera, retrieves the detected face to check whether it is a face registered in any one of short-term memory and long-term memory, counts the person of the detected face when the detected face is not retrieved from the short-term memory or the long-term memory, registers the face of the counted person in the short-term memory, transfers the face registered in the short-term memory to the long-term memory to be registered therein when the face registered in the short-term memory remains for a preset time or longer, and deletes the faces previously registered in the long-term memory in a First-In-First-Out (FIFO) manner when the number of faces registered in the long-term memory exceeds a predefined number.

Here, when the detected face is not retrieved from the short-term memory or the long-term memory, the at least one program may check whether the face detected in the currently input video frame is the same as the face detected in the previously input video frame, and may count the person of the face when the two faces are the same as each other.

Here, when the number of video frames of the face detected as the same face in the input video is equal to or greater than a preset number, the at least one program may count the person of the detected face.

Here, when the detected face is retrieved from the short-term memory, the at least one program may record a matching rate for the ID of the registered face based on the number of times the registered face that is the same as the detected face is retrieved from the short-term memory.

Here, the at least one program may transfer the face registered in the short-term memory to the long-term memory when the matching rate is equal to or less than a preset value.

Here, the at least one program may manage the number of faces registered in the long-term memory based on the predefined length of a FIFO queue.

Here, when the number of faces registered in the long-term memory exceeds the predefined length of the queue, the at least one program may delete the registered faces in the order in which they were registered.

Here, the long-term memory may include a first part in which the face transferred from the short-term memory is stored based on the length of the queue and a second part in which the faces of preregistered residents are stored.

Here, the second part of the long-term memory includes the stay duration of the residents, and the faces of the residents whose stay duration has passed may be excluded from retrieval.

The present disclosure may improve the accuracy and efficiency of a system for counting people based on face detection in an environment using existing CCTV cameras or the like.

Also, the present disclosure may improve accuracy by minimizing duplicate counting of detected faces.

As described above, the apparatus and method for counting people based on face detection according to the present disclosure are not limitedly applied to the configurations and operations of the above-described embodiments, but all or some of the embodiments may be selectively combined and configured, so the embodiments may be modified in various ways.

What is claimed is:

1. An apparatus for counting people based on face detection, comprising:
one or more processors; and
memory for storing at least one program executed by the one or more processors,
wherein the at least one program
detects a face of a person in a video input through a camera,
retrieves the detected face to check whether the detected face is a face registered in any one of short-term memory and long-term memory,
counts the person of the detected face when the detected face is not retrieved from the short-term memory or the longer-term memory,
registers the face of the counted person in the short-term memory,
transfers the face registered in the short-term memory to the long-term memory to be registered therein when the face registered in the short-term memory remains for a preset time or longer, and
deletes a face previously registered in the long-term memory in a First-In-First-Out (FIFO) manner when a number of faces registered in the long-term memory exceeds a predefined number.

2. The apparatus of claim 1, wherein, when the detected face is not retrieved from the short-term memory or the long-term memory, the at least one program checks whether the face detected in a currently input video frame is identical to a face detected in a previously input video frame and counts the person of the face when the two faces are identical to each other.

3. The apparatus of claim 2, wherein, when a number of video frames of the face detected as the identical face in the input video is equal to or greater than a preset number, the at least one program counts the person of the detected face.

4. The apparatus of claim 1, wherein, when the detected face is retrieved from the short-term memory, the at least one program records a matching rate for an ID of the registered face based on a number of times the registered face identical to the detected face is retrieved from the short-term memory.

5. The apparatus of claim 4, wherein the at least one program transfers the face registered in the short-term memory to the long-term memory when the matching rate is equal to or less than a preset value.

6. The apparatus of claim 1, wherein the at least one program manages the number of faces registered in the long-term memory based on a predefined length of a First-In-First-Out (FIFO) queue.

7. The apparatus of claim 6, wherein, when the number of registered in the long-term memory exceeds the predefined length of the queue, the at least one program deletes the registered faces in an order in which the faces are registered.

8. The apparatus of claim 7, wherein the long-term memory includes a first part in which faces transferred from the short-term memory are stored based on the length of the queue and a second part in which faces of preregistered residents are stored.

9. The apparatus of claim 8, wherein the second part of the long-term memory includes stay duration of the residents, and faces of residents whose stay duration has passed are excluded from retrieval.

10. A method for counting people based on face detection, performed by an apparatus for counting people based on face detection, comprising:
detecting a face of a person in a video input through a camera;
retrieving the detected face to check whether the detected face is a face registered in any one of short-term memory and long-term memory;
counting the person of the detected face when the detected face is not retrieved from the short-term memory or the longer-term memory;
registering the face of the counted person in the short-term memory;
transferring the face registered in the short-term memory to the long-term memory and registering the face in the long-term memory when the face registered in the short-term memory remains for a preset time or longer; and
deleting a face previously registered in the long-term memory in a First-In-First-Out (FIFO) manner when a number of faces registered in the long-term memory exceeds a predefined number.

11. The method of claim 10, wherein counting the person of the detected face comprises, when the detected face is not retrieved from the short-term memory or the long-term memory, checking whether the face detected in a currently input video frame is identical to a face detected in a previously input video frame and counting the person of the face when the two faces are identical to each other.

12. The method of claim 11, wherein counting the person of the detected face comprises, when a number of video frames of the face detected as the identical face in the input video is equal to or greater than a preset number, counting the person of the detected face.

13. The method of claim 10, wherein retrieving the detected face comprises, when the detected face is retrieved from the short-term memory, recording a matching rate for an ID of the registered face based on a number of times the registered face identical to the detected face is retrieved from the short-term memory.

14. The method of claim 13, wherein registering the face comprises transferring the face registered in the short-term memory to the long-term memory when the matching rate is equal to or greater than a preset value.

15. The method of claim 10, wherein deleting the face comprises managing the number of faces registered in the long-term memory based on a predefined length of a First-In-First-Out (FIFO) queue.

16. The method of claim 15, wherein deleting the face comprises, when the number of faces registered in the long-term memory exceeds the predefined length of the queue, deleting the registered faces in an order in which the faces are registered.

17. The method of claim 16, wherein the long-term memory includes a first part in which faces transferred from the short-term memory are stored based on the length of the queue and a second part in which faces of preregistered residents are stored.

18. The method of claim 17, wherein the second part of the long-term memory includes stay duration of the residents, and faces of residents whose stay duration has passed are excluded from retrieval.
